(19) United States
(12) Patent Application Publication
(10) Pub. No.: US 2020/0072103 A1
(43) Pub. Date: Mar. 5, 2020

(54) METHOD AND EXHAUST SYSTEM FOR CHECKING A LOADING STATE OF A PARTICLE FILTER

(71) Applicant: VOLKSWAGEN AKTIENGESELLSCHAFT, Wolfsburg (DE)

(72) Inventor: David SUDSCHAJEW, Abbesbüttel (DE)

(73) Assignee: VOLKSWAGEN AKTIENGESELLSCHAFT, Wolfsburg (DE)

(21) Appl. No.: 16/466,729

(22) PCT Filed: Dec. 1, 2017
(86) PCT No.: PCT/EP2017/081092

§ 371 Date: Jun. 5, 2019

(30) Foreign Application Priority Data
Dec. 5, 2016 (DE) 10 2016 123 426.5

(51) Int. Cl. F01N 3/023; F01N 9/00; F01N 11/00; F02D 41/02; B01D 46/00; B01D 46/46

(52) U.S. Cl. CPC F01N 3/023; F01N 9/002; F01N 11/007; F02D 41/0295; B01D 46/0086; B01D 46/0063; B01D 2279/30; F01N 2900/1606; F01N 2900/1602; F01N 2550/04; F02D 2200/0816; F02D 2200/0802; B01D 46/46

(57) ABSTRACT

A method for checking a load condition of a particulate filter in an exhaust line of an internal combustion engine, wherein the exhaust line comprises at least the particulate filter, a first lambda sensor that is arranged upstream from the particulate filter, and a second lambda sensor that is arranged downstream from the particulate filter, includes at least the following steps: introducing an exhaust gas with an excess of oxygen into the exhaust line upstream from the first lambda sensor, there being a temperature of at least 500° C. in the particulate filter; detecting the excess of oxygen by the first lambda sensor at a first time; detecting the excess of oxygen by the second lambda sensor at a second time; and determining a load condition of the particulate filter from a time difference between the first time and the second time. The invention further relates to an exhaust system of a motor vehicle.

The invention relates to a method and exhaust system for testing a load condition of a particulate filter, the particulate filter being arranged in an exhaust line of an internal combustion engine. The method is carried out in a motor vehicle.

Motor vehicles with particulate filters for filtering out particulates from the exhaust gas are generally known. It is also known that such particulate filters must be regenerated regularly, with regeneration causing the particles in the particulate trap to break down.

The moment in which regeneration is required and the effectiveness of the regeneration that is carried out is determined by sensors, for example. It is known to use pressure sensors, pressure sensor arrangements, or differential pressure sensors for this purpose. However, the use of such sensors is very costly, and these methods also yield only very inaccurate values.

It is also known to model particulate loading. However, this method also provides only estimates of when to perform regeneration and of the effectiveness of the regeneration performed.

A method for the regeneration of a particulate filter is known from US 2011/0219746 A1 in which a lambda sensor is arranged upstream and an additional lambda sensor is arranged downstream from a particulate filter.

Usually, an internal combustion engine is operated with a stoichiometric mixture ratio of fuel and oxygen. A (residual) excess of oxygen in the exhaust gas, which is characterized by a lambda value greater than 1.0, is indicative of operation of the internal combustion engine with a “lean” mixture of fuel and oxygen. A (residual) oxygen deficiency in the exhaust gas, which is characterized by a lambda value less than 1.0, is indicative of operation of the internal combustion engine with a “rich” mixture of fuel and oxygen.

In US 2011/0219746 A1, the regeneration of the particulate filter is regulated by the mixture formation for the internal combustion engine through adjustment of the oxygen content in the exhaust gas. For the regeneration of the particulate filter, an excess of oxygen in the exhaust gas upstream from the particulate filter is adjusted, so that particulates that are embedded in the particulate filter are converted oxidatively, provided that there is a minimum exhaust gas temperature of at least about 500° C. Due to the conversion of the oxygen in the particulate filter, the lambda sensor that is arranged downstream from the particulate filter indicates a fatter mixture of the exhaust gas than the lambda sensor that is arranged upstream from the particulate filter. The difference in the values measured in the exhaust gas by the lambda sensors is regarded as an indication of the ongoing regeneration and the conversion of the embedded particulates. The progression and effectiveness of the regeneration are derived from the amount of the difference.

It is the object of the present invention to at least partially solve the problems described with reference to the prior art. In particular, a method and an exhaust system for checking a load condition of a particulate filter are to be provided.

A method with the features according to claim 1 and an exhaust system according to claim 7 contribute to the achievement of these objects. Advantageous developments are the subject of the dependent claims. The features listed individually in the claims can be combined in a technologically meaningful manner and supplemented by explanatory facts from the description and/or details of the figures, with additional design variants of the invention being indicated.

The invention proposes a method for checking a load condition of a particulate filter in an exhaust line of an internal combustion engine, wherein the exhaust line comprises at least the particulate filter, a first lambda sensor that is arranged upstream from the particulate filter (in the exhaust line), and a second lambda sensor that is arranged downstream from the particulate filter (in the exhaust line), the method comprising at least the following steps:
a) introducing an exhaust gas with an excess of oxygen in the exhaust line upstream from the first lambda sensor, there being a temperature of at least 500° C. in the particulate filter;
b) detection of the excess of oxygen by the first lambda sensor at a first time;
c) detection of the excess of oxygen by the second lambda sensor at a second time;
d) determining a load condition of the particulate filter from a time difference between the first time and the second time.

The method can be used for all types of internal combustion engine (gasoline engine, diesel engine, etc.).

The load of a particulate filter refers here in particular to the amount or mass of solids (such as soot particles, for example) currently being stored in the particulate filter. The load condition can be categorized on the basis of predetermined limit values, which can be adapted and/or varied particularly in consideration of the structural design of the particulate filter, of the exhaust system, and/or of the internal combustion engine or operation thereof. Examples of load conditions can include: “empty,” “uncritical.” “regenerative,” “regeneration required,” “full”—with the specified limit value increasing in this sequence.

In the meaning used here, a particulate filter refers particularly to a so-called wall-flow filter, i.e., to a component having a multiplicity of channels (in the manner of a honeycomb structure, for example) that are particularly sealed off from one another and thus require penetration of the exhaust gas with the solids through a gas-permeable or porous wall. The solids are deposited and/or retained in the walls. As the load increases, the walls or channels become clogged.

The method is carried out when a sufficiently high temperature is present in the particulate filter at which oxidative conversion of embedded particulates can take place (usually above 500° C.).

According to step a), an exhaust gas with an excess of oxygen (lambda >1.0) is introduced into the exhaust line upstream from the first lambda sensor, so that, according to step b), the first lambda sensor then detects the change in the mixing ratio (from previously “rich” to now “lean”) and generates a first signal at a first time.

In particular, in order to ensure that the first lambda sensor detects the set oxygen excess, an exhaust gas with an oxygen deficiency (lambda <1.0) is introduced into the exhaust line (immediately) beforehand.

The exhaust gas with the excess of oxygen enters the particulate filter downstream from the first lambda sensor, with an oxidative conversion of the embedded particulates taking place within the particulate filter. As a result of the oxidative conversion, the amount of excess oxygen contained in the exhaust gas is reduced. Exhaust gas with an excess of oxygen will also occur downstream from the particulate filter only once the particulates that are embedded in the particulate filter have been converted by oxidation. Only then is the oxygen excess set in the exhaust gas detected by the second lambda sensor (step c)).

Therefore, the exhaust gas that is introduced into the exhaust line with the excess of oxygen downstream from the particulate filter will appear only with a time delay. The delay can depend on the amount/mass of the oxygen excess flowing into the particulate filter and/or on the load condition of the particulate filter. In particular, the delay also depends on the oxygen storage capacity of the particulate filter or of a catalyst as well as on its state of health. The excess of oxygen set in the exhaust gas of the internal combustion engine is known, so that the load condition of the particulate filter can be calculated from the delay of the occurrence of exhaust gas with excess oxygen at the second lambda sensor.

The proposed method thus utilizes the time difference for the detection of the excess of oxygen set in the exhaust gas between the measurement at the first lambda sensor and the measurement at the second lambda sensor.

The determination of a load condition of the particulate filter from the time difference between the first time point and the second time point can be particularly performed such that a load condition is assigned as a function of the determined or measured time difference. If the time difference lies below a first predefinable minimum limit value, the load condition “empty” can be assigned. If the time difference lies below a second (and larger) predefinable minimum limit value, the load condition can be assigned to “uncritical,” etc. If the time difference lies above a first predefinable maximum limit value, the load condition “regeneration required” can be assigned; if the time difference lies above a second (and larger) predefinable maximum limit value, the load condition “full” can be assigned, etc. Of course, mass or quantity-related load conditions can also be assigned to the limit values. In particular, it is possible to concretely specify the present load in grams or milligrams on the basis of the time difference. It is also possible for the limit values to be specified variably. The number or differentiation of the load conditions can be adapted to the application.

The load condition determined in this way can be used to check an implemented regeneration (discharge) of the particulate filter and/or to trigger a new regeneration operation.

In particular, at least during the execution of steps a), b), and c), the operation of the internal combustion engine is controlled by a natural frequency control of the lambda sensors through switching between operation with an excess of oxygen and operation with oxygen deficiency based on the identification of the changing composition of the exhaust gas by the second lambda sensor. A so-called overdriven natural frequency control is preferably used here. The operation of the internal combustion engine is not switched immediately upon detection by the second lambda sensor of the changing composition of the exhaust gas, but rather after a dead time. In particular, operation is thus carried out for a longer time with an excess of oxygen, thus ensuring regeneration of the particulate filter. This dead time is about 1 millisecond, for example, and at most about 100 milliseconds, but it can vary depending on the size of the particulate filter, its state of health, etc. As the particulate filter ages, the dead time is reduced. As the size of the particulate filter increases, the dead time is increased.

During natural frequency control and overdriven natural frequency control, the switching of the operation of the internal combustion engine (between rich and lean) is specified by the lambda sensors. In contrast, in the case of a so-called balanced lambda control, the switching takes place at a fixed and, in particular, constant frequency. Preferably, the internal combustion engine is operated continuously with the balanced lambda control, with a switch being made to natural frequency control only to determine the load condition of the particulate filter.

In particular, only slight adaptation of the oxygen content in the exhaust gas is performed during balanced lambda control. In particular, the oxygen content in the exhaust gas is set during balanced lambda control to a lambda value of greater than 0.985 and no more than 1.005, preferably of at least 0.990 and at most 1.000. During balanced lambda control, the difference between the maximum value and the minimum value is particularly no more than 0.02, preferably no more than 0.01. The lambda value can be adjusted in consideration of the measured values of the lambda sensors.

In particular, a substantially more pronounced adjustment of the oxygen content in the exhaust gas is performed during natural frequency control. Particularly, the oxygen content in the exhaust gas during natural frequency control is set to a lambda value of from 0.960 to 0.985 for a rich mixture and to a lambda value of from 1.005 to 1.020 for a lean mixture. During natural frequency control, the difference between the maximum value and the minimum value of the respective lambda values for a rich or lean mixture is particularly at least 0.02, preferably at least 0.025, especially preferably at least 0.03. An even more pronounced adjustment of the oxygen content in the exhaust gas is preferably also possible. Specifically, the oxygen content is set during natural frequency control to a lambda value of from 0.8 to 1.2, so that the difference between the maximum value and the minimum value is 0.4.

According to a preferred embodiment, at least an oxygen storage capacity of the particulate filter and a transit time of the exhaust gas from the first lambda sensor to the second lambda sensor are taken into account in step d). The oxygen storage capacity of the particulate filter affects the amount of oxygen extracted from the exhaust gas with an excess of oxygen. The oxygen stored in the particulate filter is therefore not used to convert the particles that are embedded in the particulate filter and must therefore be taken into account in the calculation of the load condition of the particulate filter from the time difference between the first time and the second time.

Furthermore, the transit time of the exhaust gas from the first lambda sensor to the second lambda sensor (which varies as a function of the operating point of the internal combustion engine, for example) must be taken into account for the calculation of the load condition. For example, if the particulate filter has only a low particulate load, the exhaust gas with the excess of oxygen will flow through the particulate filter without substantial conversion of oxygen contained in the exhaust gas. The time difference between the first time and the second time will then depend essentially only on the flow rate of the exhaust gas (depending on the operating point of the internal combustion engine). The time difference can also be influenced by the oxygen storage capacity of the particulate filter.

Any arrangement and design of lambda sensors can be used for this purpose. Two different types of lambda sensor are known. On the one hand, there is the broadband lambda sensor, which generates a measurement signal proportional to the oxygen content of the exhaust gas. On the other hand, there is the so-called two-point lambda sensor (or jump sensor), in which only two very different values are generated as a measurement signal. Thus, the two-point lambda sensor can only indicate switching between oxygen excess operation and oxygen deficiency operation, whereas the broadband lambda sensor can indicate the amount of oxygen present in the exhaust gas.

Preferably, a first lambda sensor of a broadband lambda sensor type is used in step b), and a second lambda sensor of a two-point lambda sensor type is preferably used in step c). With a two-point lambda sensor as the second lambda sensor, the second time of the penetration of the exhaust gas with excess oxygen can be detected by the particulate filter and displayed. Particularly, a more accurate indication of the specific proportion of oxygen in the exhaust gas is not required. The particulate load of the particulate filter is determined exclusively by the time difference between the first time and the second time.

The method is especially suitable for a particulate filter having no catalytically active coating. In particular, the particulate filter therefore has no additional coating provided for a catalytic conversion of pollutants contained in the exhaust gas. Such a catalytic coating is known to be subject to aging phenomena, so that the conversion of particles can be influenced differently by the excess of oxygen made available in the exhaust gas. A non-catalytically coated particulate filter is not subject to these aging phenomena, so that the calculation carried out in step d) can be carried out more accurately.

Preferably, the method is used when the particulate filter (or its upstream end face) is arranged at a distance of no more than 80 centimeters from (an outlet of) a combustion chamber of the internal combustion engine along an (idealized) flow line through the exhaust line. The flow line runs particularly along a center line of the exhaust gas line (and thus runs through the area centers of the cross sections of the exhaust gas line). Such an arrangement of the particulate filter near the engine makes improved operation of the internal combustion engine possible during natural frequency controlling of the lambda sensors in which switching is performed between operation with an excess of oxygen and operation with oxygen deficiency based on detection of the changing composition of the exhaust gas by the second lambda sensor. The short distance of the particulate filter from the internal combustion engine makes faster switching possible between the abovementioned modes (rich/lean).

The proposed method enables a load condition of a particulate filter that is arranged in the exhaust gas line to be detected. In particular, the effectiveness of a regeneration of the particulate filter that was performed can also be checked in this way.

Furthermore, an exhaust system of a motor vehicle is proposed which comprises at least one exhaust line, one particulate filter arranged in the exhaust line, one first lambda sensor arranged upstream from the particulate filter (in the exhaust line) and one second lambda sensor arranged downstream from the particulate filter (in the exhaust line), and a control unit for detecting (set or expected) measurement signals of the first lambda sensor and the (associated or resulting/also expected) measurement signals of second lambda sensor. A time difference between a first measurement signal of the first lambda sensor and a second measurement signal of the second lambda sensor can be detected and evaluated by a control unit. For this purpose, the control unit can be set up with appropriately adapted signal connections and computing power. The control unit can also be part of a superordinate structural assembly such as an engine management system, for example.

The control unit of the exhaust system is intended and set up particularly for the purpose of carrying out the proposed method. In particular, the control unit identifies at what times an exhaust gas that is introduced into the exhaust gas line with an excess of oxygen reaches the lambda sensors. The detected time difference between these times is used particularly to determine a load condition of the particulate filter. A small time difference indicates that there is only a small load on the particulate filter. A larger time difference indicates a greater loading of the particulate filter.

Preferably, the first lambda sensor is a broadband lambda sensor and the second lambda sensor is a two-point lambda sensor. Other arrangements of lambda sensors are also possible, however.

In particular, the particulate filter has no catalytically active coating.

Preferably, the particulate filter (or its upstream end face) is arranged at a distance along an flow line through the exhaust line of no more than 80 centimeters from (an outlet of) a combustion chamber of the internal combustion engine. The flow line runs particularly along a center line of the exhaust gas line (and thus runs through the area centers of the cross sections of the exhaust gas line).

Furthermore, a motor vehicle is proposed that at least has an internal combustion engine with an exhaust system, the exhaust system having at least one exhaust line, one particulate filter arranged in the exhaust line, one first lambda sensor arranged upstream from the particulate filter (in the exhaust line) and one second lambda sensor arranged downstream from the particulate filter (in the exhaust line), as well as a control unit for detecting measurement signals of the first lambda sensor and of the second lambda sensor. A time difference between a first measurement signal of the first lambda sensor and a second measurement signal of the second lambda sensor can be detected and evaluated by a control unit. The control unit of the exhaust system is intended and set up particularly for the purpose of carrying out the proposed method.

The remarks concerning the proposed method are applicable to the proposed exhaust system and/or to the motor vehicle, and vice versa.

The invention and the technical environment will be explained in greater detail with reference to the figures. It should be noted that the invention is not intended to be limited by the embodiments shown. In particular, unless explicitly stated otherwise, it is also possible to extract partial aspects of the features explained in the figures and to combine them with other components and insights from the present description and/or figures. In particular, it should be pointed out that the figures and, in particular, the illustrated proportions are only schematic. Same reference symbols designate same objects, so that explanations of other figures can be consulted where necessary. In the drawing:

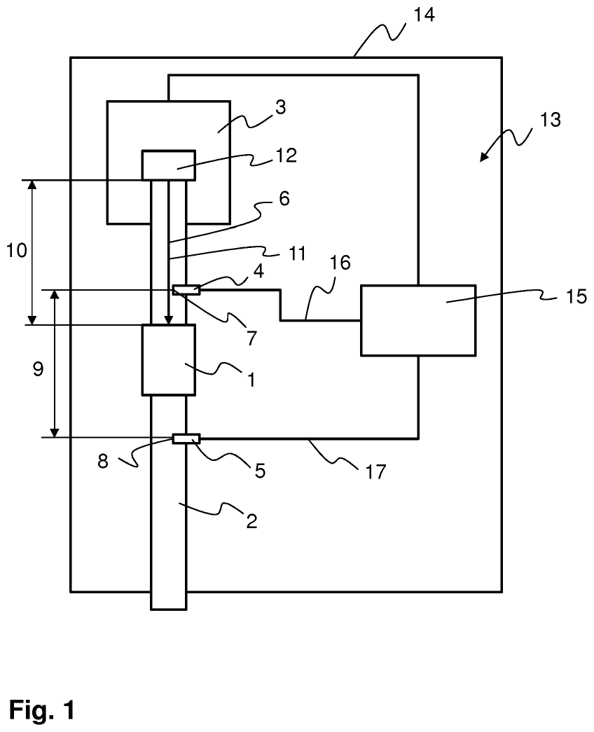

FIG. 1 shows a motor vehicle;

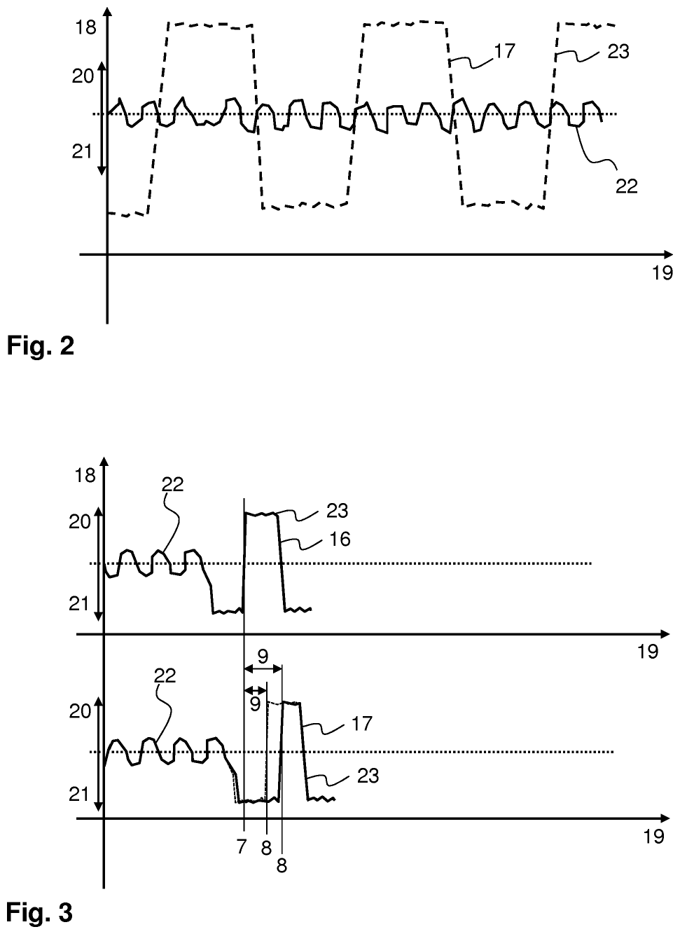

FIG. 2 shows a lambda value/time diagram; and

FIG. 3 shows the procedure of the method in a lambda value/time diagram.

FIG. 1 shows a motor vehicle 14 is that comprises an internal combustion engine 3 with an exhaust system 13, the exhaust system 13 having at least one exhaust line 2, one particulate filter 1 arranged in the exhaust line 13, one first lambda sensor 4 arranged upstream from the particulate filter 1 (in the exhaust line 2) and one second lambda sensor 5 arranged downstream from the particulate filter 1 (in the exhaust line 2), as well as a control unit 15 for detecting measurement signals 16 of the first lambda sensor 4 and of the second lambda sensor 5. A time difference 9 between a first measurement signal 16 of the first lambda sensor 4 and a second measurement signal 17 of the second lambda sensor 5 can be detected and evaluated by a control unit 15. For instance, an excess of oxygen of an exhaust gas 6 that is introduced into the exhaust line 2 can be detected by the first lambda sensor 4 at a first time 7 and by the second lambda sensor 5 at a second time 8.

The particulate filter 1 (or its upstream end side) is arranged at a distance 10 along an (idealized) flow line 11 through the exhaust line 2 from (an outlet of) a combustion chamber 12 of the internal combustion engine 3. The flow line 11 extends along a center line of the exhaust gas line 2 (and thus runs through the area centers of the cross sections of the exhaust gas line 2).

FIG. 2 shows a lambda value/time diagram. The lambda value 18 is plotted on the vertical axis, with the lambda value of 1.00 being clarified by the horizontal dotted line. Superstoichiometric lambda values 20 lie above this line, and substoichiometric lambda values 21 lie below this line. The time 19 is plotted on the horizontal axis.

The different controls for the switching of the operation of the internal combustion engine 3 are illustrated here. The dashed line represents the progression of the second measurement signals 17 of the second lambda sensor 5. During the execution of steps a), b), and c), the operation of the internal combustion engine 3 is controlled by a natural frequency control 23 of the lambda sensors 4, 5 through switching between operation with an excess of oxygen (superstoichiometric lambda value 20) and operation with oxygen deficiency (substoichiometric lambda value 21) based on the identification of the changing composition of the exhaust gas 6 by the second lambda sensor 5.

During natural frequency control 23, the switching of the operation of the internal combustion engine 3 is specified by the lambda sensors 4, 5. In contrast, in the case of a so-called balanced lambda control 22, which is represented here by the solid line, the switching takes place at a fixed and constant frequency.

Only slight adaptation of the oxygen content in the exhaust gas 6 is performed during balanced lambda control 22. A substantially more pronounced adjustment of the oxygen content in the exhaust gas 6 is performed during natural frequency control 23.

FIG. 3 shows the procedure of the method in a lambda value/time diagram. The lambda value 18 is plotted on the vertical axis, with the lambda value of 1.00 being clarified by the horizontal dotted line. Superstoichiometric lambda values 20 lie above this line, and substoichiometric lambda values 21 lie below this line. The time 19 is plotted on the horizontal axis. The upper diagram shows the progression of the first measurement signals 16 of the first lambda sensor 4. The lower diagram shows the progression of the second measurement signals 17 of the second lambda sensor 5.

The method starts by switching from the balanced lambda control 22 to the natural frequency control 23. At first, a rich mixture (substoichiometric lambda value 21) is introduced as exhaust gas 6 into the exhaust gas line 2. After the switch to a lean mixture (superstoichiometric lambda value 20), the first lambda sensor 4 registers the exhaust gas 6 with the excess of oxygen at the first time 7. In step a), an exhaust gas with an excess of oxygen is thus introduced into the exhaust line 2 upstream from the first lambda sensor 4, there being a temperature of at least 500° C. in the particulate filter 1. In step b), the excess of oxygen in the exhaust gas 6 is detected by the first lambda sensor 4 at a first time 7. In step c), the excess of oxygen is detected by the second lambda sensor at a second time 8. In step d), the load condition of the particulate filter 1 is calculated from a time difference 9 between the first time 7 and the second time 8.

In the lower diagram, the dashed line of the natural frequency control 23 shows the progression of the second measurement signals 17 of the second lambda sensor 5 when the particulate filter 1 has only a low particulate load. The continuous line of the natural frequency control 23 shows the progression of the second measurement signals 17 of the second lambda sensor 5 when the particulate filter 1 has a high particulate load. It can be seen here that, when the particulate filter 1 has a low particulate load, the time difference 9 is small, and when the particulate filter 1 has a high particulate load, the time difference 9 is large.

The exhaust gas 6 with the excess of oxygen enters the particulate filter 1 downstream from the first lambda sensor 4, with an oxidative conversion of the embedded particulates taking place within the particulate filter 1. As a result of the oxidative conversion, the amount of excess oxygen contained in the exhaust gas 6 is reduced. Exhaust gas 6 with an excess of oxygen will also occur downstream from the particulate filter 1 only once the particulates that are embedded in the particulate filter 1 have been converted by oxidation. Only then is the oxygen excess set in the exhaust gas 6 detected by the second lambda sensor 5 (step c)).

Therefore, the exhaust gas 6 that is introduced into the exhaust line 2 with the excess of oxygen downstream from the particulate filter 1 will appear only with a time delay. The delay depends on the amount of the oxygen excess flowing into the particulate filter 1 on the one hand and on the load condition of the particulate filter 1 on the other hand. The set excess of oxygen is known (e.g., from the control unit 15, via which the mixture of fuel and air to be supplied to the combustion chambers 12 of the internal combustion engine 3 is set), so that it is possible to calculate the load condition of the particulate filter 1 from the delay of the occurrence of exhaust gas 6 with an excess of oxygen at the second lambda sensor 5.

The oxygen storage capacity of the particulate filter 1 and the transit time of the exhaust gas 6 from the first lambda sensor 4 to the second lambda sensor 5 are additionally taken into account in step d). If the particulate filter 1 has only a low particulate load, the exhaust gas 6 with the excess of oxygen will flow through the particulate filter 1 without substantial conversion of oxygen contained in the exhaust gas 6. The time difference 9 between the first time 7 and the second time 8 then depends essentially only on the flow rate of the exhaust gas 6 (depending on the operating point of the internal combustion engine 3). The time difference 9 can also be influenced by the oxygen storage capacity of the particulate filter 1.

### LIST OF REFERENCE SYMBOLS

1 particulate filter
2 exhaust line
3 internal combustion engine
4 first lambda sensor
5 second lambda sensor
6 exhaust gas
7 first time
8 second time
9 time difference
10 distance
11 flow line
12 combustion chamber
13 exhaust system
14 motor vehicle
15 control unit
16 first measurement signal
17 second measurement signal
18 lambda value
19 time
20 superstoichiometric lambda value (lambda value >1; exhaust gas with oxygen excess)
21 substoichiometric lambda value (lambda value <1; exhaust gas with oxygen deficiency)
22 balanced lambda control
23 natural frequency control

1. A method for checking a load condition of a particulate filter in an exhaust line of an internal combustion engine, wherein the exhaust line comprises at least the particulate filter, a first lambda sensor that is arranged upstream from the particulate filter, and a second lambda sensor that is arranged downstream from the particulate filter, the method comprising at least the following steps:
a) introducing an exhaust gas with an excess of oxygen into the exhaust line upstream from the first lambda sensor, there being a temperature of at least 500° C. in the particulate filter;
b) detecting the excess of oxygen by the first lambda sensor at a first time;
c) detecting the excess of oxygen by the second lambda sensor at a second time; and
d) determining a load condition of the particulate filter from a time difference between the first time and the second time.

2. The method as set forth in claim 1, wherein, at least during the execution of steps a), b), and c), the operation of the internal combustion engine is controlled by a natural frequency control of the lambda sensors through switching between operation with an excess of oxygen and operation with oxygen deficiency based on the identification of the changing composition of the exhaust gas by the second lambda sensor.

3. The method as set forth in claim 2, wherein the oxygen content in the exhaust gas during natural frequency control is set to a lambda value of from 0.960 to 0.985 for a rich mixture and to a lambda value of from 1.005 to 1.020 for a lean mixture.

4. The method as set forth in claim 3, wherein a difference between the maximum value and the minimum value of the respective lambda values is at least 0.02.

5. The method as set forth in claim 1, wherein at least an oxygen storage capacity of the particulate filter and a transit time of the exhaust gas from the first lambda sensor to the second lambda sensor are taken into account in step d).

6. The method as set forth in claim 1, wherein a first lambda sensor of a broadband lambda sensor type is used in step b), and a second lambda sensor of a two-point lambda sensor type is preferably used in step c).

7. An exhaust system of an internal combustion engine of a motor vehicle, comprising at least:
one exhaust line,
one particulate filter arranged in the exhaust line,
one first lambda sensor arranged upstream from the particulate filter,
one second lambda sensor arranged downstream from the particulate filter, and
a control unit for detecting measurement signals of the first lambda sensor and of the second lambda sensor, the control unit (15) being configured to detect and evaluate a time difference between a first measurement signal of the first lambda sensor and a second measurement signal of the second lambda sensor.

8. The exhaust system as set forth in claim 7, wherein the first lambda sensor is a broadband lambda sensor and the second lambda sensor is a two-point lambda sensor.

9. The exhaust system as set forth in claim 7, wherein the particulate filter has no catalytically active coating.

10. The exhaust system as set forth in claim 7, wherein the particulate filter is arranged at a distance of no more than 80 centimeters from a combustion chamber of the internal combustion engine along a flow line through the exhaust line.
